(19) United States
(12) Patent Application Publication
(10) Pub. No.: US 2026/0249889 A1
(43) Pub. Date: Aug. 27, 2026

(54) Cargo Restraint Panel with Friction Layer

(71) Applicant: MBull Holdings, LLC, North Miami Beach, FL (US)

(72) Inventor: Matthew Bullock, McLean, VA (US)

(21) Appl. No.: 19/061,025

(22) Filed: Feb. 24, 2025

(51) Int. Cl. B61D 45/00; B32B 3/04; B32B 3/30; B32B 5/18

(52) U.S. Cl. CPC B61D 45/006; B32B 3/04; B32B 3/30; B32B 5/18; B32B 2307/744; B32B 2607/00

(57) ABSTRACT

A cargo restraint panel may comprise a foam core, one or more side caps covering one or more sides of the foam core, and an enhanced friction layer. Enhanced friction layers of cargo restraint panels may contact dunnage materials and help prevent or reduce movement of those dunnage materials during transport.

### BACKGROUND

Cargo transported by rail may take the form of cargo units such as boxes, crates, drums, reinforced bags, plastic wrapped bundles, cased goods, metal coils, specialty heavy paper rolls, plastic or metal containers mounted on pallets, other types of palletized cargo, etc. To prevent damage caused by forward and/or reverse acceleration of railcars, cargo units may be restrained from forward or rearward movement. Polymer foam panels may be used to provide such restraint. In addition to providing restraint, such panels offer advantages over various types of dunnage materials. When used in combination with various types of dunnage materials, however, performance of those dunnage materials may be affected.

### SUMMARY

This Summary is provided to introduce a selection of some concepts in a simplified form as a prelude to the Detailed Description. This Summary is not intended to identify key or essential features.

A cargo restraint panel may comprise a foam core, one or more side caps covering one or more sides of the foam core, and one or more flexible enhanced friction layers forming one or more portions of an exterior face of the cargo restraint panel. The enhanced friction layer(s) may be positioned on a face of the foam core so as to contact dunnage materials. The flexible enhanced friction layer(s) may be configured to provide additional grip of dunnage materials to prevent the dunnage materials from sliding out of position during transportation.

These and other features are described in more detail below.

### BRIEF DESCRIPTION OF THE DRAWINGS

Some features are shown by way of example, and not by way of limitation, in the figures of the accompanying drawings and in which like reference numerals refer to similar elements.

FIGS. 1A and 1B show an example of cargo unit restraint in a railcar.

FIG. 2A is a front view of an example cargo restraint panel having one or more flexible enhanced friction layers.

FIGS. 2B and 2C are side views of the cargo restraint panel of FIG. 2A.

FIGS. 3A, 3B, and 3C show another example of a cargo restraint panel having one or more flexible enhanced friction layers.

FIGS. 4A, 4B, and 4C show another example of a cargo restraint panel having one or more flexible enhanced friction layers.

FIGS. 5A and 5B show additional examples cargo restraint panels having one or more flexible enhanced friction layers.

FIG. 6A, 6B, 6C, and 6D show an example of the flexible enhanced friction layer that wraps continuously around a cargo restraint panel.

FIG. 7 is an area cross-sectional from the location indicated in FIG. 2A.

FIG. 8A is a plan view of a portion of another example enhanced friction layer.

FIG. 8B is an area cross-sectional view from the location indicated in FIG. 8A.

FIG. 9A is a plan view of a portion of another example enhanced friction layer.

FIG. 9B is an area cross-sectional view from the location indicated in FIG. 9A.

FIG. 10A is a plan view of a portion of another example enhanced friction layer.

FIG. 10B is an area cross-sectional view from the location indicated in FIG. 10A.

FIG. 11A is a plan view of a portion of another example enhanced friction layer.

FIG. 11B is an area cross-sectional view from the location indicated in FIG. 11A.

FIG. 12A and 12B are respective front and side views of a polymer foam core of any of the cargo restraint panels of FIGS. 2A-5B.

FIG. 13 is an area cross-sectional view, from the location indicated in FIG. 2C, of a side cap.

FIG. 14 is an area cross-sectional view, from the location indicated in FIG. 2A, of another side cap.

FIG. 15 shows use of cargo restraint panels described herein with dunnage material.

FIG. 16 is a flow chart showing an example method of using cargo restraint panels described herein with cargo units and dunnage materials.

### DETAILED DESCRIPTION

Cargo restraint panels may be used to separate cargo units in a railcar and to protect those cargo units from damage due to excessive forces when the railcar is abruptly moved. Examples of cargo restraint panels and of their use may be found in U.S. Patent No. 9,333,899, U.S. Patent No. 9,637,044, U.S. Patent No. 10,427,583, U.S. Patent No. 11,220,205, U.S. Patent No. 11,618,370, U.S. Patent Application Pub. No. 2022/0097595, and U.S. Patent Application Pub. No. 2023/0191980, all of which are incorporated by reference herein. Cargo restraint panels may sometimes be used in combination with dunnage air bags. Dunnage air bags are bags/bladders that may be inflated with air and placed between cargo units to prevent cargo units from moving and slamming into each other. However, use of dunnage air bags, including use with cargo restraint panels, may be associated with one or more problems. For example, as cargo units (or load restraint panels) separated by dunnage air bags are subjected to forward and reverse G forces (e.g., from starting and stopping railcars, from connection of railcars to form a train), small movements of those cargo units or cargo restraint panels may tend to work a dunnage air bag from one position (e.g., a lower position) to another position (e.g., a higher position), ultimately creating voids that allow shifting and/or damage of cargo units. This problem may be exacerbated if dunnage air bags have lost volume (e.g., because of a leak or because of an increase in atmospheric pressure subsequent to initial inflation).

Described herein are cargo restraint panels that help address such problems. In one embodiment, a cargo restraint panel may be configured to provide stability to cargo units during transportation and reduce movement that may cause shifting and/or damage to the cargo units. A cargo restraint panel may include a front face and a rear face that may come into contact with the cargo units and/or other cargo restraint panels. The cargo restraint panels may also include a plurality of sides, extending between the front face and the rear face. Further, the cargo restraint panel may comprise one or more layers of a material on the front and/or rear faces having a higher coefficient of static friction than other materials (e.g., facing materials) forming other portions the front and/or rear faces of the panel. The enhanced friction layer may be a flexible material. The flexible enhanced friction layer may be positioned on some or all of the portions of the faces of the cargo restraint panel that come into contact with dunnage materials (e.g., dunnage air bags). As the cargo units and cargo restraint panels are subject to forward and reverse G forces, the region(s) of higher friction contacting the dunnage materials may provide a gripping force and reduce movement of the dunnage materials.

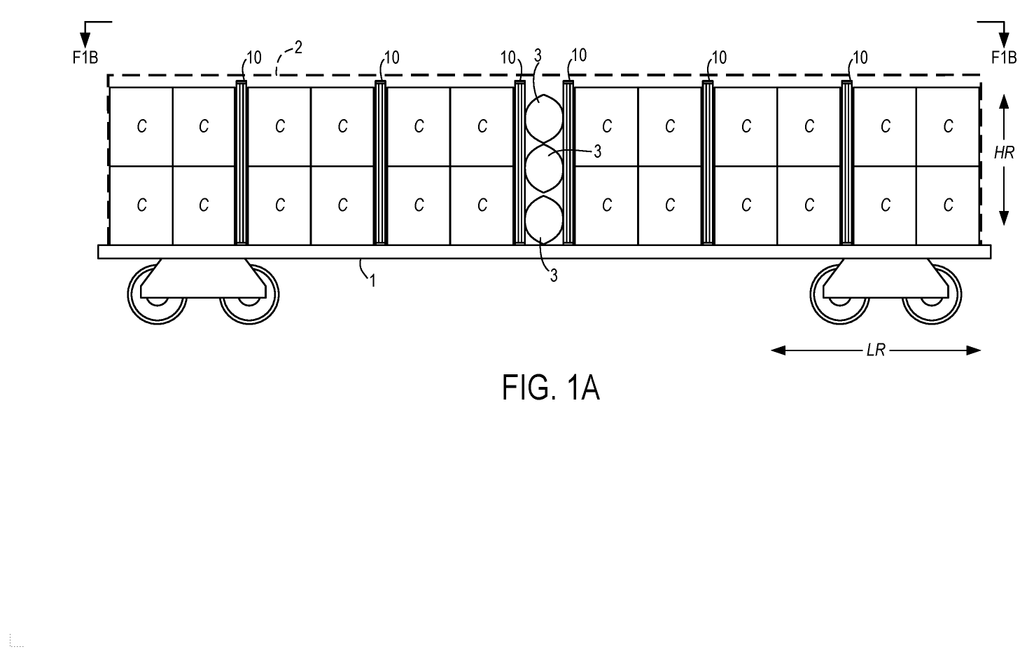

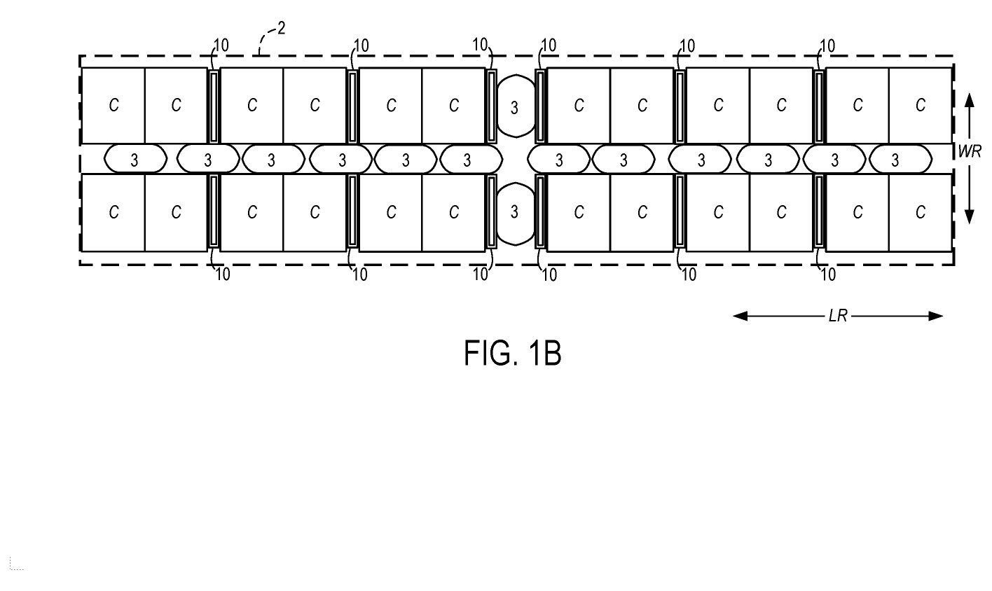

FIG. 1A is a partially schematic side view of a loaded railcar 1 showing an example of restraint of cargo units C using cargo restraint panels 10. The panels 10 may be any of the cargo restraint panels that are described in detail in connection with subsequent drawing figures. FIG. 1B is a partially schematic top view of the loaded railcar 1. In FIGS. 1A and 1B, the top, the side walls, and the end walls of the railcar 1 have been omitted for purposes of explanation. An outline 2 of the inner surfaces of the railcar 1 ceiling, side walls, and end walls is shown with broken lines. For convenience, a length axis LR, a width axis WR, and a height axis HR are also indicated. Subsequent references to length, width, or height within a railcar refer to dimensions along the axes LR, WR, and HR, respectively.

Situated within the railcar 1 are a plurality of cargo units C. For convenience, the cargo units C in the example of FIGS. 1A and 1B are uniformly sized. Along the axis WR, the cargo units C are separated by dunnage materials (e.g., dunnage air bags). Other types of dunnage materials can also or alternatively be used to fill voids between the cargo units C in the direction of axis WR, axis LR, and/or between the cargo units C and a side wall of the railcar 1. In the direction of axis LR, the cargo restraint panels 10 are interposed between some of the cargo units C.

As seen in FIGS. 1A and 1B, the cargo units C are restrained from movement in the direction of the axis LR by the presence of the panels 10, by the presence of dunnage materials 3, and by the presence of other cargo units. In particular, each of the cargo units C is restrained from movement along axis LR by elimination of gaps between the front and rear of that cargo unit C and the next object (e.g., another cargo unit C, a panel 10, dunnage materials 3, an end wall of railcar 1) along axis LR.

The arrangement of the cargo units C and the cargo restraint panels 10 shown in FIGS. 1A and 1B is merely one example of cargo restraint using cargo restraint panels such as are described herein. Cargo units of different sizes and/of non-uniform sizes may be restrained using cargo restraint panels such as are described herein, and such cargo units may be arranged in another manner. The quantity and/or arrangement of cargo restraint panels and/or dunnage materials may be varied from what is shown in FIGS. 1A and 1B. For example, more or fewer cargo units may be positioned directly adjacent along the LR axis (e.g., without an intervening cargo restraint panel), and/or cargo units may be stacked in more than two layers and/or not stacked. Cargo restraint panels of other shapes and sizes may also or alternatively be used.

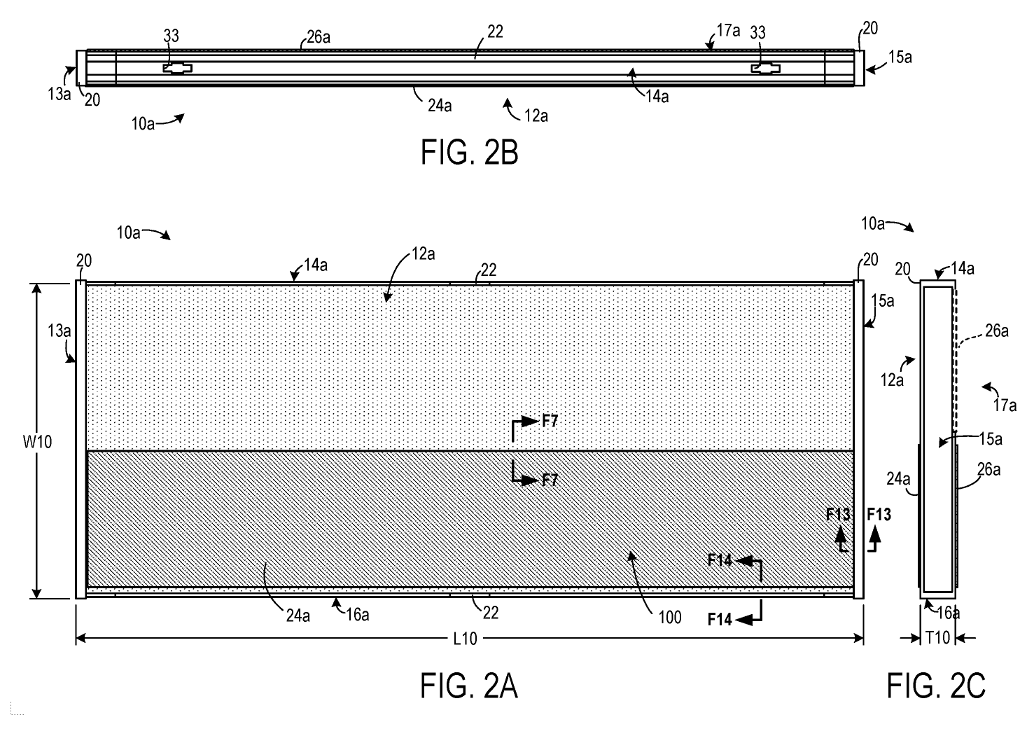

FIG. 2A is a front view of an example cargo restraint panel 10a comprising a panel front 12a and four panel sides 13a, 14a, 15a, and 16a. FIG. 2B is a side view of the panel 10a facing the panel side 14a, and further shows a panel rear 17a of the cargo restraint panel 10a. The cargo restraint panel 10a may be rectangular, with opposite panel sides 14a and 16a being longer than opposite panel sides 13a and 15a. The structure of the panel side 14a may be the same as or similar to the structure of the panel side 16a, and the structure of the panel rear 17a may be the same as or similar to the structure of the panel front 12a. FIG. 2C is a side view of the cargo restraint panel 10a facing the panel side 15a. The structure of the panel side 13a may be the same as or similar to the structure of the panel side 15a. The panel 10a may have a length L10 (e.g., 108 inches), a width W10 (e.g., 36 inches), and a thickness T10 (e.g., 4 inches). These dimensions are only examples, however. As additional examples, L10 may range from 48 inches to 108 inches, W10 may range from 24 inches to 60 inches, and/or T10 may range from 1 inch to 12 inches, and a cargo restraint panel may have dimensions that comprise any combination of a value for L10 selected from the aforementioned range of L10 values, a value for W10 selected from the aforementioned range of W10 values, and a value for T10 selected from the aforementioned range of T10 values. As further examples, a cargo restraint panel may have dimensions that comprise values for L10, W10, and/or T10 that are outside of the aforementioned ranges.

The panel sides 13a and 15a may comprise side caps 20. As explained in more detail below, the cargo restraint panel 10a may comprise a polymer foam core. The side caps 20 may cover a pair of opposing sides of the polymer foam core. The cargo restraint panel 10 may also have a second set of side caps 22 on a second pair of opposing sides (e.g., the panel sides 14a and 16a). The side caps may extend over a portion of the panel front 12a and the panel rear 17a. A flexible enhanced friction layer 24a (indicated by cross-hatching) may be located on all or a part of the panel front 12a. As explained in more detail below, the enhanced friction layer 24a may be adhered to the panel front 12a. Optionally, there may be a second flexible enhanced friction layer 26a located on all or a part of the panel rear 17a. The second enhanced friction layer 26a may be the same as or similar to the enhanced friction layer 24a.

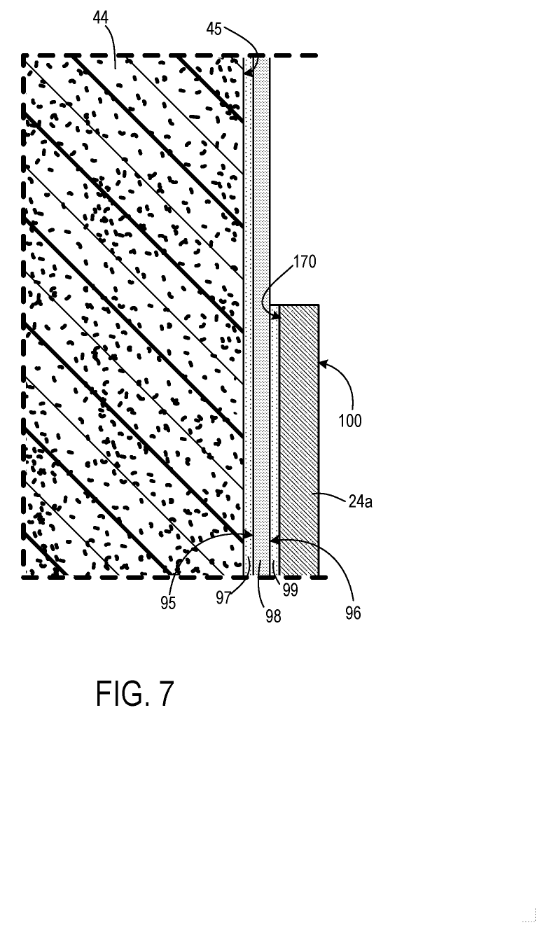

The enhanced friction layer 24a may have an interior face 170 (shown in FIG. 7) in contact with and adhered to a foam core of the panel 10a and/or to another material (e.g., a facing material) covering that foam core, as also explained in connection with FIG. 7. An exterior face 100 of the enhanced friction layer faces outward on the panel front 12a. The enhanced friction layer 24a may extend a part or the whole of the length L10 and/or width W10 of the panel 10a.

As shown in FIG. 2A, the enhanced friction layer 24a is located on a portion of the panel front 12a that is near or adjacent to panel side 16a and extends substantially the entire length L10 and abuts the side caps 20. The enhanced friction layer 24a extends only a portion of the panel width W10 (shown as approximately half the width W10). As shown in FIG. 2C, which shows a side view of the panel 10a exposing panel side 15a, enhanced friction layer 26a may similarly be located on a portion of the panel rear 17a that is near or adjacent to the panel side 16a and may (as shown in FIG. 2B) extend substantially the whole length L10 of the panel 10a and abut the side caps 20. Alternatively, and as shown in broken line in FIG. 2C, the enhanced friction layer 26a may be offset from the enhanced friction layer 24a and be located on a portion of the panel rear 17a that is near or adjacent to the panel side 14a.

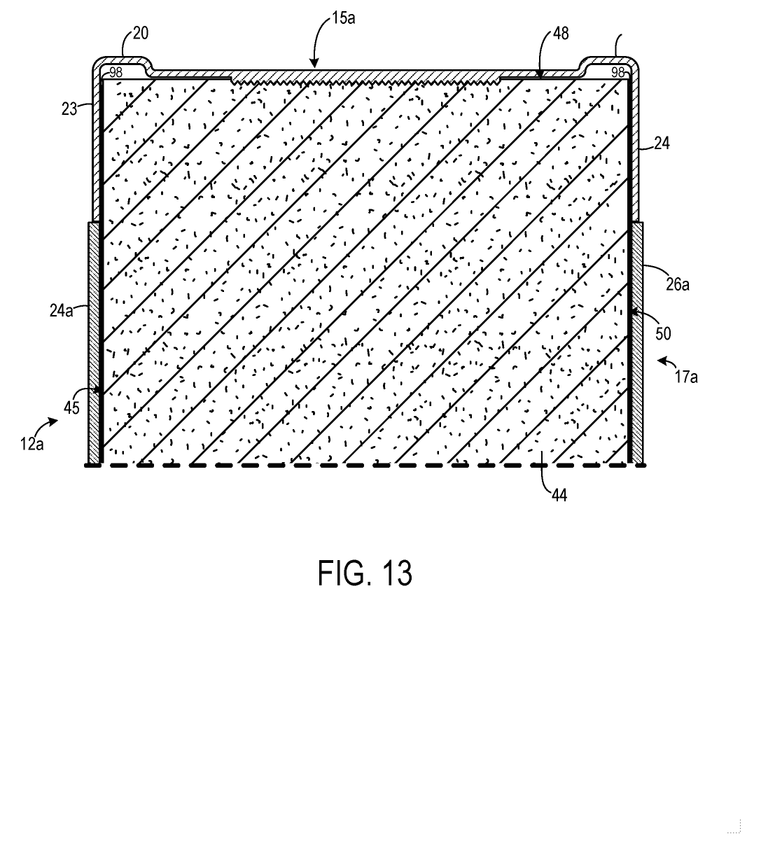

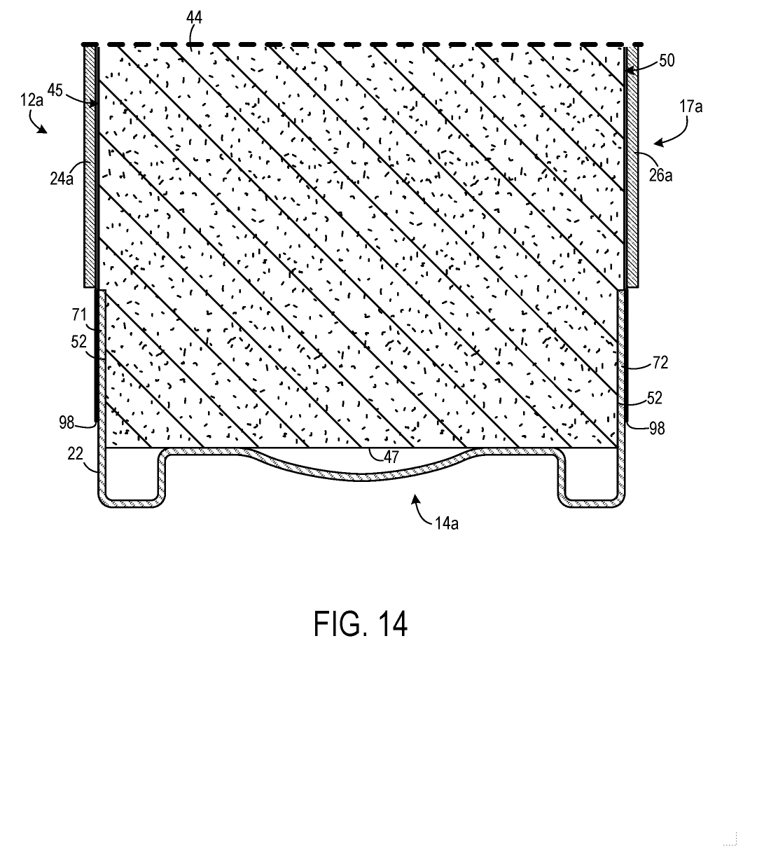

For convenience, the enhanced frictions layers 24a and 24b are shown in FIGS. 2B and 2C as extending beyond the side caps 20 and 22 (e.g., having a thickness greater than flanges of the side caps 20 and 22, as shown in FIGS. 13 and 14). Other enhanced friction layers in other panels are similarly shown in other drawing figures. However, material used for an enhanced friction layer may have a thickness less than a thickness of a side cap flange. In such an example, that enhanced friction layer may not be visible in a view such as the views of FIGS. 2B and 2C.

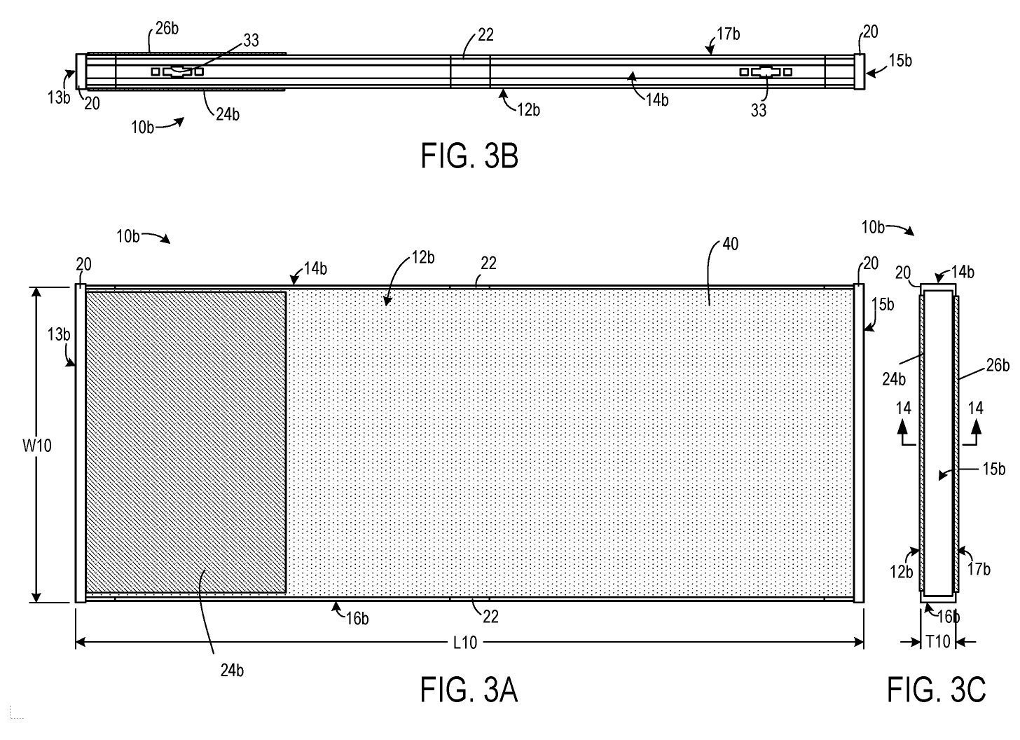

FIG. 3A shows an example cargo restraint panel 10b (comprising a panel front 12b, a panel rear 17b, and four panel sides 13b, 14b, 15b, and 16b) that is similar to panel 10a, but in which enhanced friction layers 24b and 26b, respectively located on the panel front 12b and the panel rear 17b, are located near or adjacent the panel side 13b. The enhanced friction layers 24b and 26b extend substantially the entirety of the width W10 (e.g., abutting side caps 22) and only a portion of the length L10 of the panel 10b. Alternatively, the enhanced friction layer 26b may be offset from the enhanced friction layer 24b and located elsewhere along the length L10 (e.g., near or adjacent to the panel side 15b).

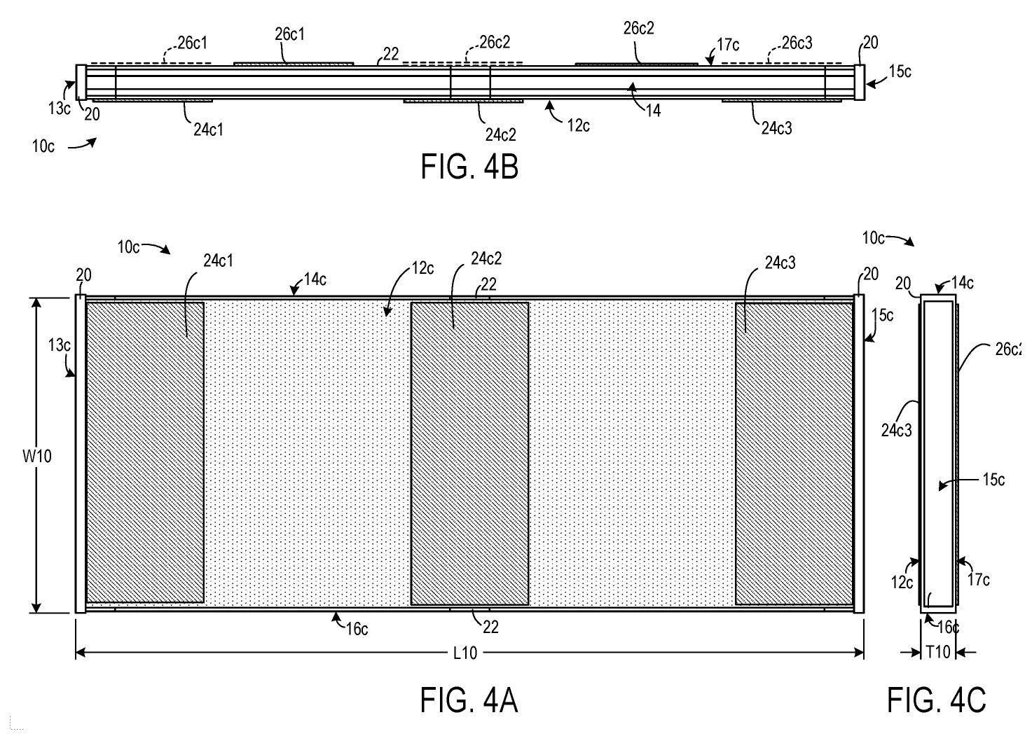

FIG. 4A shows an example cargo restraint panel 10c (comprising a panel front 12c, a panel rear 17c, and four panel sides 13c, 14c, 15c, and 16c) that is similar to the panels 10a and 10b, but in which enhanced friction layers may have another configuration. Flexible enhanced friction layers 24c1,24c2, and 24c2 are parallel strips positioned on the front 12c and extending substantially the entire width W10. Enhanced friction layer 24c1 may be located near or adjacent to the panel side 13c (e.g., abutting the side cap 20 on the panel side 13c), enhanced friction layer 24c3 may be located near or adjacent to the panel side 15c (e.g., abutting the side cap 20 on the panel side 15c), and the enhanced friction layer 24c2 may be located between the layers 24c1 and 24c3, with a gap separating the layers 24c1 and 24c2 and a gap separating the layers 24c2 and 24c3. Flexible enhanced friction layers 26c1 and 26c2 are parallel strips, similar to the layers 24c1, 24c2, and 24c3, positioned on rear the 17c and extending substantially the entire width W10. Layer 26c1 is located in a portion of the rear 17c opposite the gap between the layers 24c1 and 24c2. The layer 26c2 is located in a portion of the rear 17c opposite the gap between the layers 24c2 and 24c3. Alternatively, and as indicated by broken lines in FIG. 4B, the layers 26c1 and 26c2 could be positioned opposite the layers 24c1 and 24c2, respectively, and a layer 26c3 (similar to the layers 26c1 and 26c2) could be located opposite layer 24c3.

In the example cargo restraint panels 10a, 10b, and 10c, and in other example cargo restraint panels, the enhance friction layer(s) for a panel may cover less than all of a panel front or panel rear. Cargo restraint panels may be configured in this way to save cost and/or to save weight. However, a cargo restraint panel may comprise an enhanced friction layer that covers substantially all of a panel front and/or a panel rear.

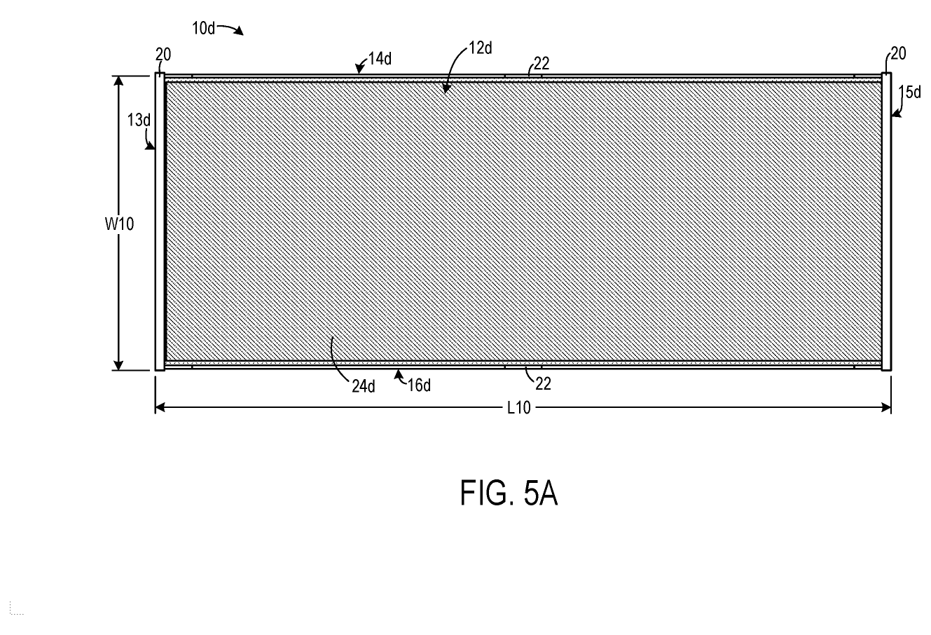

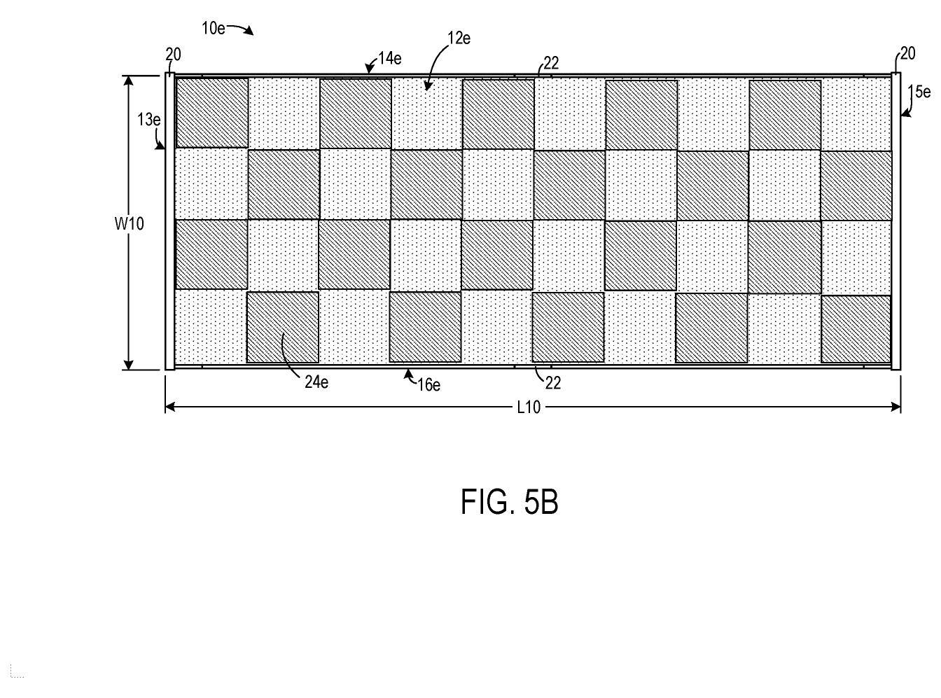

FIG. 5A shows an example cargo restraint panel 10d (comprising a panel front 12d and four panel sides 13d, 14d, 15d, and 16d) that is similar to the panels 10a, 10b, and 10c, but in which an enhanced friction layer 24d covers substantially all of the panel front 12d. Edges of the layer 24d may be near or abut the sides 13d, 14d, 15d, and/or 16d. A rear of the panel 10d, not shown, may comprise one or more enhanced friction layers in the configuration shown for the panel front 12d or in a configuration shown for a panel front or panel rear shown in any of the other drawing figures.

FIG. 5B shows an example cargo restraint panel 10e (comprising a panel front 12e and four panel sides 13e, 14e, 15e, and 16e) that is similar to the panels 10a, 10b, 10c, and 10d, but in which enhanced friction layers 24e are arranged in a pattern that extends across substantially all of the panel front 12e. Although a checkerboard pattern is shown in FIG. 5B, any other pattern or other arrangement may be used, and friction layers 24e may have shapes other than square and/or have different shapes. A rear of the panel 10e, not shown, may comprise one or more enhanced friction layers in the configuration shown for the panel front 12e or in a configuration shown for a panel front or panel rear shown in any of the other drawing figures.

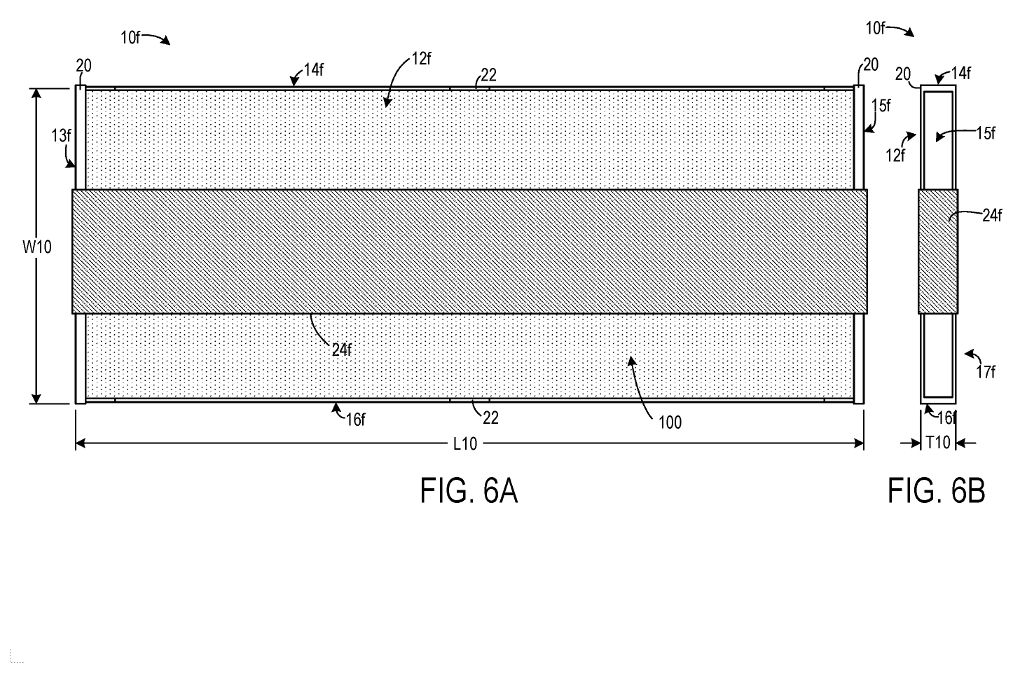

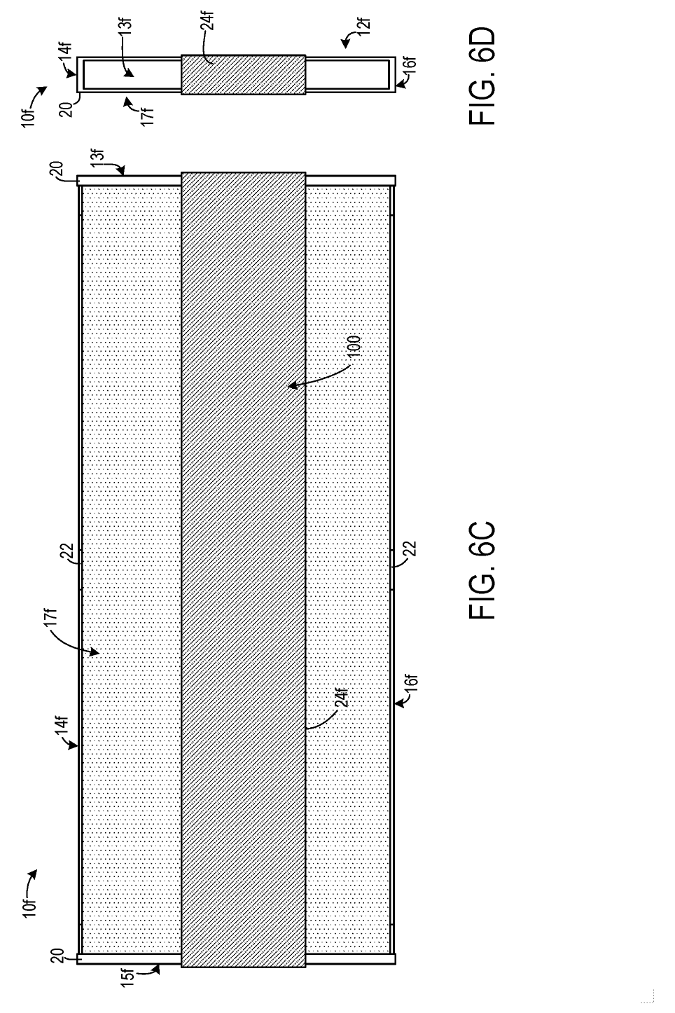

FIGS. 6A-6D respectively show a front 12f, side 15f, rear 17f, and side 13f of a cargo restraint panel 10f (also comprising sides 14f and 16f) that is similar to the panels 10a, 10b, 10c, 10d, and 10e, but in which an enhanced friction layer 24f is wrapped (e.g., continues uninterrupted) across the front 12f, side 15f, rear 17f, and side 13f. Also or alternatively, a flexible enhanced friction layer may be wrapped across the front 12f, side 14f, rear 17f, and side 16f. Also or alternatively, a flexible enhanced friction layer may be wrapped across the front 12f, side 15f, rear 17f, and side 13f prior to attachment of the side caps 20 (e.g., so that the side caps 20 cover portions of the enhanced friction layer wrapping around the sides 13f and 15f). Also or alternatively, a flexible enhanced friction layer may be wrapped across the front 12f, side 14f, rear 17f, and side 16f prior to attachment of the side caps 22 (e.g., so that the side caps 22 cover portions of the enhanced friction layer wrapping around the sides 14f and 16f).

FIG. 7 is enlarged, partially schematic, area cross-sectional view from the location indicated in FIG. 2A. In FIG. 7 and in other drawings figures, heavy broken lines are used to indicate portions of a cross-sectional (or other) view that have been omitted. The interface between other enhanced friction layers described herein (e.g., any of layers 24a – 24f or other layers 24 described in connection with other drawing figures) and facing materials on a front (e.g., any of fronts 12a – 12f) or rear (e.g., any of rears 17a – 17f) of other panels described herein (e.g., any of panels 10a – 10f) may have a structure similar to that shown in FIG. 7. For convenience, reference number 10 (without an appended letter) generically refers to any of the panels 10a – 10f or other cargo restraint panels described herein, reference number 12 (without an appended letter) generically refers to any of the fronts 12a – 12f or fronts of other cargo restraint panels described herein, reference number 17 (without an appended letter) generically refers to any of the rears 17a – 17f or rears of other cargo restraint panels described herein, and reference numbers 24 and 26 (without an appended letter) generically refers to any of the enhanced friction layers 24a – 24f, 26a – 26c3, or other enhance friction layers described herein.

The enhanced friction layer 24a, and any of the other enhance friction layers 24 or 26 described herein may be comprised of one or more materials that have enhanced friction. Examples of such materials may comprise, without limitation, one or more natural rubbers, one or more synthetic rubbers, and/or one or more silicone compounds. Also or alternatively, an enhanced friction layer may comprise a coating of a low-tack acrylic pressure-sensitive adhesive (PSA). Also or alternatively, an enhanced friction layer may comprise a hook and loop system component material (e.g., a VELCRO® Brand hook and loop fastener system component material) that is configured to interact with a complementary hook and loop system component material on a dunnage air bag or other dunnage material (e.g., an enhanced friction layer may comprise a hook material configured to interact with a loop material on a surface of a dunnage air bag, or vice versa). As described in more detail in connection with subsequent drawing figures, the exterior face 100 may also or alternatively comprise one or more other types of surface features to further enhance friction. The interior face 170 of the enhanced friction layer 24a may be adhered, via an adhesive layer 99, to an exterior face 96 of a facing material layer 98. In regions of front 12a where enhanced friction layer 24a is absent (and in similar regions in fronts 12 or rears 17 of other panels 10 where an enhanced friction layer 24 or 26 is absent), an exterior face 96 of a facing material layer 98 may be exposed. A static coefficient of friction of an exposed face of an enhanced friction layer (e.g., the face 100) may be higher than 0.5 and/or may be higher than a static coefficient of friction of an exposed face of a facing material (e.g., the portion of exterior face 96 in FIG. 7). Facing material 98 may, for example, comprise a woven textile with high denier stitch and/or a coated fabric. Also or alternatively, the facing material 98 may comprise a spun bonded polyethylene fiber material (e.g., material sold under the trade name TYVEK), other types of spun bonded polymer fibers, polyester film(s), polyethylene terephthalate film(s) (e.g., such as films sold under the trade name MYLAR), other polymer film(s), paper, woven natural (e.g., cotton) and/or synthetic fibers, knitted natural and/or synthetic fibers, felted natural and/or synthetic fibers, stitchbond fabrics, and/or other materials (e.g., any facing materials or combinations of facing materials, including fiber-reinforced combinations of materials, described in the patents and published patent applications described above). An interior face 95 of the facing material layer 98 may be adhered, via an adhesive layer 97, to an exterior face 45 of a foam core 44. The adhesive layers 97 and 99 may comprise the same adhesive or may comprise different types of adhesive. The adhesive layer 97 and/or the adhesive layer 99 may comprise a substrate layer (not shown). Adhesives that may be used for either of the adhesive layers 97 and 99 include, without limitation, laminating adhesives (e.g., an ethylene vinyl acetate water based copolymer adhesive), acrylic adhesives, soft cyanoacrylates, polyurethane reactive (PUR) adhesives, and/or hot melt adhesives (e.g., amorphous poly olefin (APO) and/or amorphous poly alpha olefin (APAO)). The foam core 44 may comprise a resilient, compressible material. The core 44 may, for example, comprise a sheet of extruded polystyrene (XPS) foam having a nominal density of 2.0 pounds per cubic foot (PCF) and a minimum ASTM D1621 compressive strength of 60 pounds per square inch (psi). Expanded polystyrene (EPS) having similar properties may be used. Other grades of EPS, XPS, and/or other polymer foams may be used. Examples of EPS that may be used comprise ASTM C 578 Type XI (0.70 - 0.89 PCF), Type I (0.9 - 1.14 PCF), Type VIII (1.15 - 1.34 PCF), Type II (1.35 - 1.79 PCF), and/or Type IX (1.80 - 2.20 PCF), and/or EPS Geofoam (e.g., ASTM D6817 EPS12 Type XI, EPS15 Type 1, EPS19 Type VIII, EPS 22 Type II, EPS29 Type IX, EPS 39 Type XIV, and/or EPS46). Examples of XPS that may be used comprise ASTM C 578-95 Type X, Type IV, Type VI, Type VII, and/or Type V. Also or alternatively, the core 44 may comprise a sheet of polyurethane foam, polyethylene foam, melamine foam, and/or another foam, any of which may have a density and/or other properties similar to those of one or more of the aforementioned EPS and/or XPS foams. Also or alternatively, the core 44 may comprise a sheet of a non-polymer foam or of a foam-like material that mimics the properties of a polymer foam (e.g., that mimics one or more properties of a polymer foam such as one or more of the aforementioned EPS and/or XPS foams). Examples of such foam-like materials comprise natural or artificial sponge. Also or alternatively, the core 44 may comprise a sheet of natural or artificial cork. The core 44 may be formed from a single monolithic piece of a single material or may comprise multiple foam (or other compressible material) panels or blocks that have been bonded together to form a single unit.

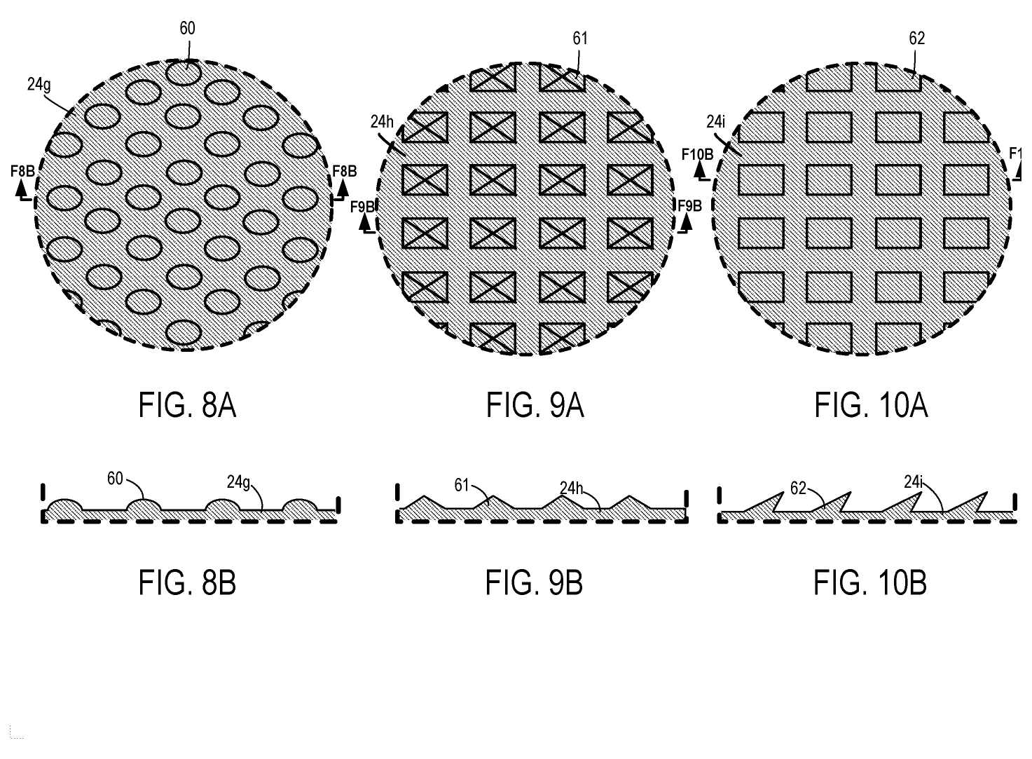

A flexible enhanced friction layer 24 or 26 may have one or more surface features on an exterior face to increase friction. FIG. 8A is a plan view of a portion of an exterior face of an enhanced friction layer 24g having rounded surface features 60. FIG. 8B is partially schematic area cross-sectional view, from the location indicated in FIG. 8A, of the portion of the enhanced friction layer 24g. FIG. 9A is a plan view of a portion of an exterior face of an enhanced friction layer 24h having pointed, pyramidal shaped surface features 61. FIG. 9B is partially schematic area cross-sectional view, from the location indicated in FIG. 9A, of the portion of the enhanced friction layer 24h. FIG. 10A is a plan view of a portion of an exterior face of an enhanced friction layer 24i having saw-toothed features 62. FIG. 10B is partially schematic area cross-sectional view, from the location indicated in FIG. 10A, of the portion of the enhanced friction layer 24i. The sizes, shapes, and arrangements of surface features in FIGS. 8A – 10B are only examples, and an enhanced friction layer may have surface features that comprise different shapes and/or sizes and/or that may be arranged differently. An enhanced friction region 24 may have surface features on an exterior face that are of different sizes and/or shapes and/or that may be in groups having different arrangements. An enhanced friction layer 26 may have any of the surface features described above (or elsewhere herein) for an enhanced friction layer 24.

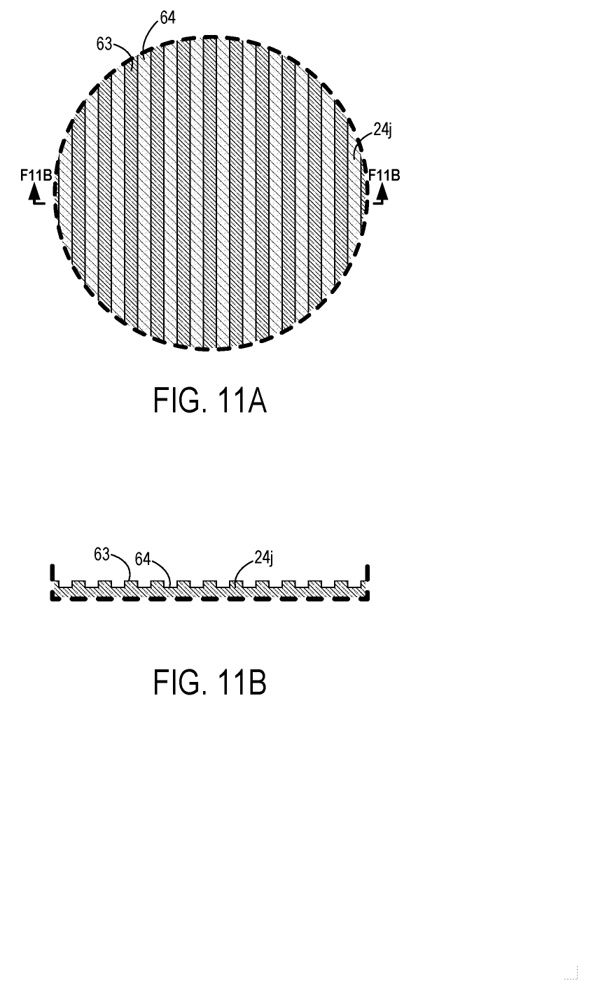

Also or alternatively, surface features on an exterior face of an enhanced friction layer may be arranged to form grooves, ridges, channels, and/or other elongated shapes. FIG. 11A is a plan view of an exterior surface of an enhanced friction layer 24j. The exterior face of the layer 24j comprises ridges 63 separated by valleys 64. FIG. 11B is partially schematic area cross-sectional view, from the location indicated in FIG. 11A, of the portion of the enhanced friction layer 24j. Ridges and valleys need not be straight. For example, ridges and valleys may be formed in a herringbone pattern, a curved pattern, or in any other pattern or arrangement. Ridges need not have rectangular cross sections, and may have rounded, pointed, saw-toothed, or other shaped cross-sections. Ridges and/or valleys need not be regularly spaced and/or shaped (e.g., some ridges may have different cross-sections and/or have different sizes than other ridges, some valleys may have different cross-sections and/or have different sizes than other valleys). Grooves, ridges, channels, and/or other elongated shapes may be combined with surface features such those shown in FIGS. 8A – 10B and/or with other surface features.

Surface features need not cover an entire exterior face of an enhanced friction layer. One or more portions of an exterior face may be smooth and one or more other portions may comprises surface features such as described above.

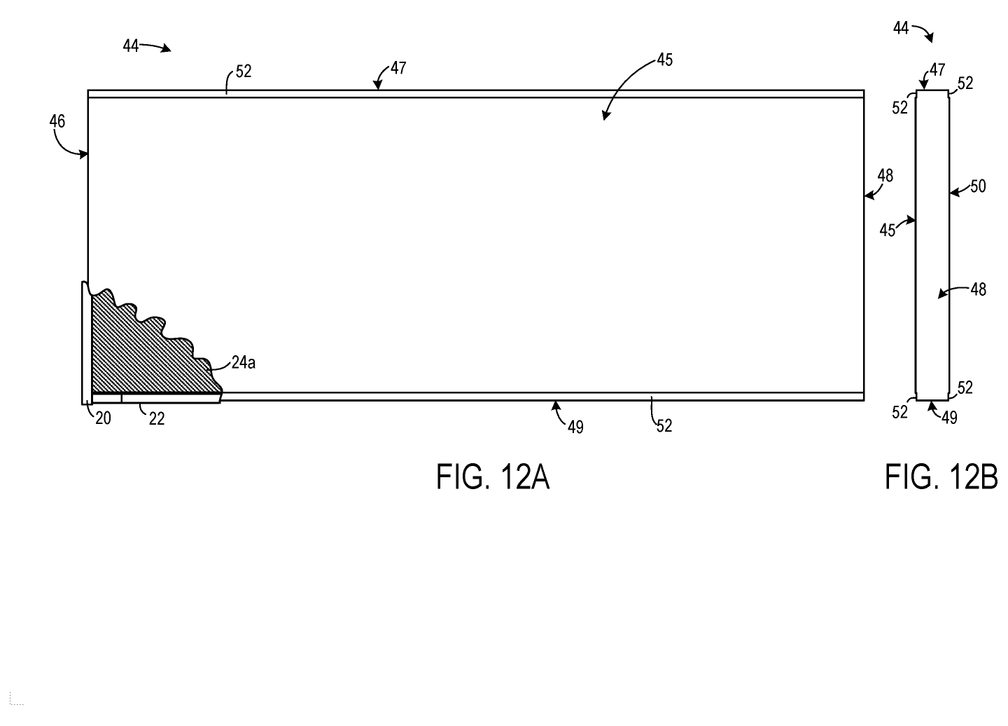

FIG. 12A is a front view of the polymer foam core 44 of the cargo restraint panel 10a. Foam cores 44 of other cargo restraint panels 10 may have a similar structure. A portion of the side cap 20, the side cap 22, and the flexible enhanced friction layer 24a corresponding to a corner of the cargo restraint panel 10a are included in FIG. 12A to partially indicate locations of those components relative to the core 44. The core 44 may be a single piece of polymer foam or may comprise multiple layers and/or sections. The core 44 may comprise a core front 45 that corresponds to the panel front 12a, a core side 46 that corresponds to the panel side 13a, a core side 47 that corresponds to the panel side 14a, a core side 48 that corresponds to the panel side 15a, and a core side 49 that corresponds to the panel side 16a. FIG. 12B is a side view of the core 44 facing the core side 48. The core 44 may further comprise a core rear 50 that corresponds to the panel rear 17a. Rabbets (e.g., two-sided open-ended recesses) 52 may be formed at edges of the core front 45 adjacent the core sides 47 and 49. Similar rabbets 52 may be formed at edges of the core rear 50 adjacent the core sides 47 and 49.

The structure of side cap 20 on panel side 13a may be the same or substantially the same as the side cap 20 on panel side 15a. The structure of the side cap 22 on panel side 14a may the same or substantially the same as the side cap 22 on the panel side 6a. The side caps 20 and 22 may have a structure as described in U.S. Patent No. 11,618,370, previously incorporated by reference herein.

FIG. 13, an enlarged, 90° CCW rotated, partially schematic area cross-sectional view taken from the location indicated in FIG. 2A, shows the enhanced friction layers 24a and 26a respectively abutting edges of front flange 55 and front flange 23 and rear flange 24 of side cap 20. The enhanced friction layers 24a and 26a may similarly abut edges of a front flange and a rear flange of side cap 20 on side 13a. An enhanced friction layer 24 may alternatively extend over a front and/or a rear flange of a side cap 20. An enhanced friction layer 24 may alternatively extend under a front and/or a rear flange of a side cap 20 (e.g., between a front flange and a foam core, and/or between a rear flange and a foam core). Side caps 20, which may be side caps such as are described in U.S. Patent No. 11,618,370, may be extruded, molded, or otherwise formed from one or more plastics. An example material from which the side caps 20 may be formed is a polyolefin such as a high density polyethylene (HDPE), a medium density polyethylene (MDPE), and/or a low density polyethylene (LDPE). Also or alternatively, the side caps 20 may be formed other materials that comprise polycarbonate (PC), acrylonitrile butadiene styrene (ABS), polyvinyl chloride (PVC), polypropylene, and/or other polymers.

FIG. 14, an enlarged, partially schematic area cross-sectional view taken from the location indicated in FIG. 2A, shows the enhanced friction layers 24a and 26a respectively terminating near edges of front flange 71 and rear flange 72 of side cap 22. Facing material 98 is adhered to core front 45 and to an exterior face of the front flange 71, with the enhanced friction layer 24a adhered to an exterior face of the facing material 98 covering the core front 45. Facing material 98 is adhered to core rear 50 and to an exterior face of rear flange 72, with the enhanced friction layer 26a adhered to an exterior face of the facing material 98 covering the core rear 50. An enhanced friction layer may extend over a front or rear flange of a side cap 22. If facing material 98 extends under front or rear flange of a side cap 22 (or if facing material is omitted in the region of that flange), an enhanced friction layer 24 may alternatively extend under that flange. Side caps 22, which may be side caps such as are described in U.S. Patent No. 11,618,370, may be extruded, molded, or otherwise formed from one or more plastics. An example material from which the side caps 22 may be formed is a polyolefin such as a high density polyethylene (HDPE), a medium density polyethylene (MDPE), and/or a low density polyethylene (LDPE). Also or alternatively, the side caps 20 may be formed other materials that comprise polycarbonate (PC), acrylonitrile butadiene styrene (ABS), polyvinyl chloride (PVC), polypropylene, and/or other polymers.

Facing material 98 may be omitted in one or more regions in which an enhanced friction layer 24 is present. For example, some or all of an interior face 170 of an enhanced friction layer 24 may be bonded (e.g., via an adhesive) directly to a face (e.g., a core front 45 or a core rear 50) of a foam core 44.

A cargo restraint panel 10 may be assembled by installing side caps 22 on the core sides 47 and 49. Optionally, adhesive may be applied to the rabbets 52 to bond to inner surfaces of the flanges 71 and 72. Facing material 98 may be bonded with adhesive to core front 45 and to core rear 50, with portions of the facing material being bonded to exterior faces of flanges of the side caps 22. One or more flexible enhanced friction layers 24 may bonded (e.g., using adhesive) to one or more regions of the core front 45 covered by facing material 98 (and/or to one or more regions of the core front 45 where facing material 98 was omitted). One or more flexible enhanced friction layers 26 may bonded (e.g., using adhesive) to one or more regions of the core rear 50 covered by facing material 98 (and/or to one or more regions of the core rear 50 where facing material 98 was omitted). Side caps 20 may be installed over the core sides 46 and 48, either before or after enhanced friction layer 24 have been bonded.

A cargo restraint panel may comprise a combination of different enhanced friction layers, with each of those enhanced friction layers having any combination of the friction layer materials, surface features, shapes, sizes, configurations, or other features described herein.

Although examples of cargo restraint panels described above and shown in the drawings are rectangular and comprise a substantially planar and parallel front and rear, this is not required. A cargo restraint panel may comprise one or more side caps and/or one or more other features described herein, but may have a non-rectangular shape. For example, such cargo restraint panels may have less than four sides or more than four sides. Such cargo restraint panels may be all or partially circular, may be all or partially elliptical, or otherwise have an at least partially curved shape. Fronts and rears need not be planar and may be curved, may be faceted, and/or may have other configurations. A front and a rear of a cargo restraint panel need not be parallel.

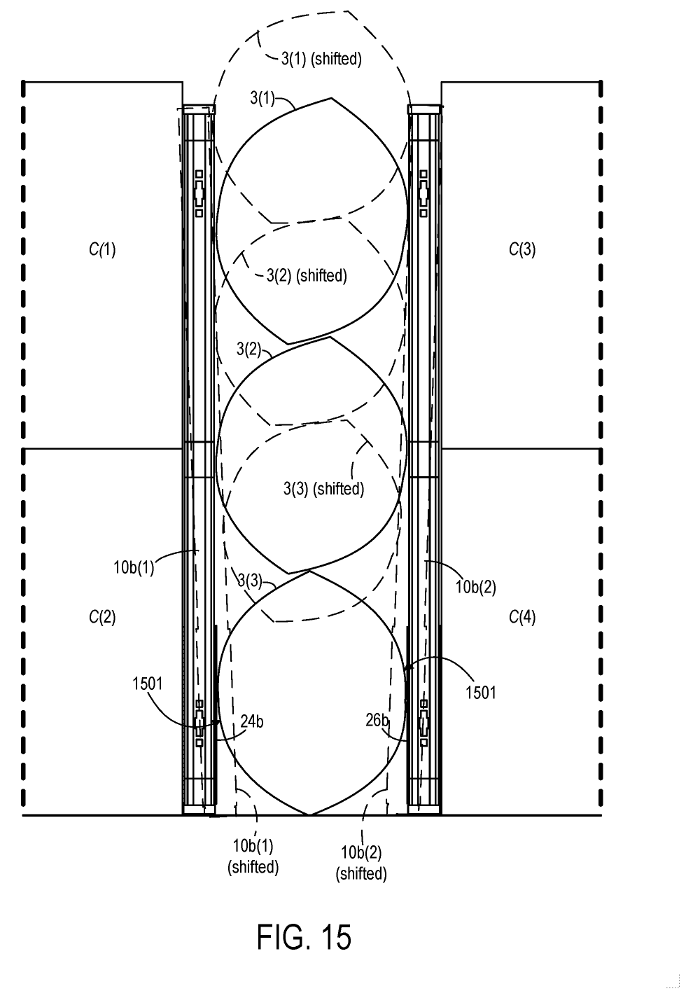

FIG. 15 shows an example use of cargo restraint panels described herein with dunnage air bags. The example of FIG. 15 shows two cargo restraint panels 10b(1) and 10b(2), each of which is similar to the cargo restraint panels 10b of FIGS. 3A – 3C. Other cargo restraint panels 10 may be used in a manner similar to that shown in FIG. 15. A rear of the panel 10b(1) contacts cargo units C(1) and C(2) loaded in a railcar. A front of the panel 10b(2) contacts cargo units C(3) and C(4) loaded in the railcar. Inflated dunnage air bags 3(1), 3(2), and 3(3) are positioned between, and contact, the panels 10b(1) and 10b(2). The dunnage air bag 3(3) contacts an enhanced friction layer 24b of panel 10b(1) and an enhanced friction layer 26b of panel 10b(2). Optionally, a surface 1501 of dunnage air bag 3(3) may comprise a hook and loop fastener system component material (e.g., if the enhanced friction layer 24b and/or the enhanced friction layer 26b comprise(s) a complementary hook and loop fastener system component material).

During transport, and/or as the railcar moves at other times (e.g., when the railcar is being added to a train), forward and reverse G forces cause the panels 10b(1) and 10b(2) to alternately apply and release compressive force on the dunnage air bags 3(1) – 3(3). This may tend to work the air bags 3(1) – 3(3) upward. If the enhanced friction layers 24b and 26b of the panels 10b(1) and 10b(2) were absent, the air bags 3(1) – 3(3) may be moved upward, as shown in broken lines, leaving a gap between the lower portions of the panels 10b(1) and 10b(2), and allowing the lower portions of panels 10b(1) and 10b(2) to move closer together (as also shown in broken lines). With the enhanced friction layers 24b and 26b of the panels 10b(1) and 10b(2) present, the dunnage air bag 3(3) is less likely to move upward. Even if the dunnage airbags 3(1) and 3(2) are still worked upward, separation between the upper and lower portions of the panels 10b(1) and 10b(2) (and the stability of the cargo units C(1) – C(4)) is more likely to be maintained, as the upward movement of the dunnage air bags 3(1) and 3(2) is likely to be limited by the ceiling of the railcar or by other structures. As can be appreciated from the above description, movement of the dunnage air bags 3(1) and 3(2) may be limited by use of panels 10 having other configurations of enhanced friction layers (e.g., enhanced friction layers that contact the air bags 3(1) and 3(2)).

Although the example of FIG. 15 shows the use of cargo restraint panels 10 with air dunnage bags, cargo restraint panels 10 may similarly be used with other types of dunnage materials.

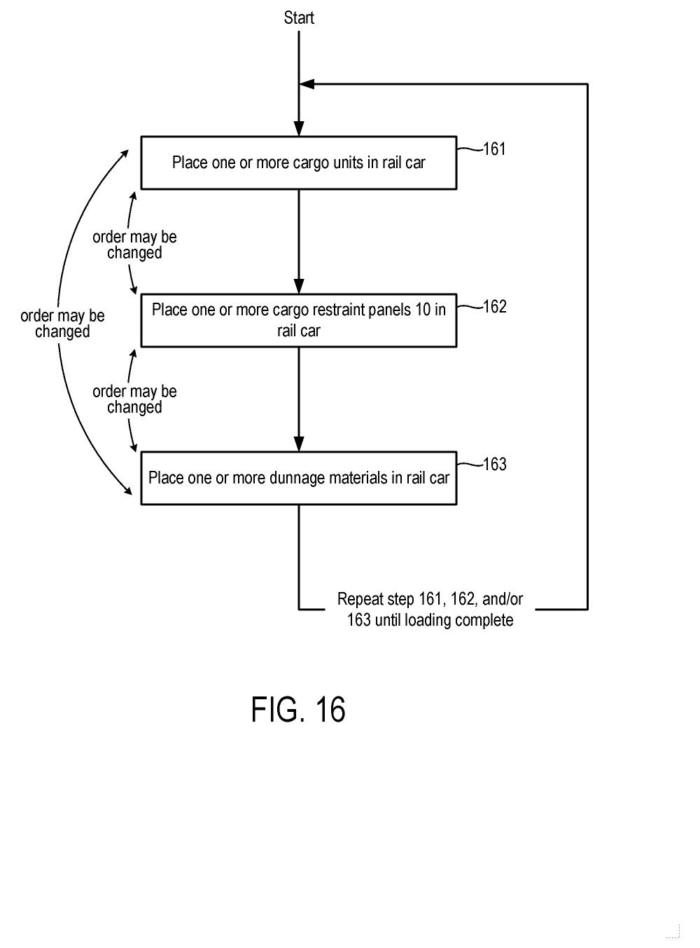

FIG. 16 is a flow chart showing an example method of using cargo restraint panels described herein with cargo units and dunnage materials. In step 161, one or more cargo units may be loaded/placed in a railcar. In step 162, one or more cargo restraint panels 10 may be loaded placed in the railcar. In step 163, one or more dunnage materials (e.g., dunnage air bags) may be loaded/placed in the railcar. The steps 161, 162, and/or 163 may be performed in any order, and/or two or more of the steps may be performed simultaneously. The steps 161, 162, and/or 163 may be repeated until loading of the railcar is complete.

As a result of performing steps 161, 162, and 163, cargo units and cargo restraint panels are arranged, in a front to rear direction of the railcar, in alternating groups of one or more cargo units separated by one or more restraint panels (e.g., as shown in FIGS. 1A, 1B, and 15). Also as result of performing steps 161, 162, and 163, dunnage materials (e.g., one or more dunnage air bags) are located between, and are partially compressed by, a first cargo restraint panel and a second cargo restraint panel, with at least a portion of the dunnage materials in contact with an exposed surface of an enhanced friction layer of the first cargo restraint panel (e.g., an exposed surface of the enhanced friction layer 24b of the panel 10b(1) of FIG. 15) and at least a portion of the dunnage materials in contact with an exposed surface of an enhanced friction layer of the second cargo restraint panel (e.g., an exposed surface of the enhanced friction layer 26b of the panel 10b(2) of FIG. 15)).

The foregoing has been presented for purposes of example. The foregoing is not intended to be exhaustive or to limit features to the precise form disclosed. The examples discussed herein were chosen and described in order to explain principles and the nature of various examples and their practical application to enable one skilled in the art to use these and other implementations with various modifications as are suited to the particular use contemplated. The scope of this disclosure encompasses, but is not limited to, any and all combinations, subcombinations, and permutations of structure, operations, and/or other features described herein and in the accompanying drawing figures.

1. A cargo restraint panel comprising:
a foam core comprising a core front, a core rear, and a plurality of core sides extending between the core front and the core rear;
a first side cap that covers a first core side of the plurality of core sides, a first portion of the core front adjacent to the first core side, and a first portion of the core rear adjacent to the first core side;
a second side cap that covers a second core side of the plurality of core sides, a second portion of the core front adjacent to the second core side, and a second portion of the core rear adjacent to the second core side; and
an enhanced friction layer, covering at least a portion of the core front and having a first exposed surface forming at least a portion of an exterior face of a front of the cargo restraint panel, that comprises one or more of: a natural rubber, a synthetic rubber, a silicone, a low-tack acrylic pressure-sensitive adhesive, or a hook and loop fastener system component material.

2. The cargo restraint panel of claim 1, wherein the first exposed surface comprises surface features that comprise one or more of ridges or protrusions.

3. The cargo restraint panel of claim 1, further comprising:
a front barrier covering at least a portion of the core front and having a second exposed surface forming a second portion of the exterior face of the front of the cargo restraint panel, wherein a static coefficient of friction of the first exposed surface is greater than a static coefficient of friction of the second exposed surface.

4. The cargo restraint panel of claim 3, wherein:
the cargo restraint panel is rectangular in shape;
first and second sides of the cargo restraint panel, respectively corresponding to the first side cap and the second side cap, are longer than third and fourth sides of the cargo restraint panel; and
the enhanced friction layer extends along substantially all of the third side and is absent from a portion of the exterior face that is adjacent to, and that extends along substantially all of, the fourth side of the cargo restraint panel.

5. The cargo restraint panel of claim 3, wherein:
the cargo restraint panel is rectangular in shape,
first and second sides of the cargo restraint panel, respectively corresponding to the first side cap and the second side cap, are longer that third and fourth sides of the cargo restraint panel, and
the enhanced friction layer extends along substantially all of the second side and is absent from a portion of the exterior face that is adjacent to, and that extends along substantially all of, the first side of the cargo restraint panel.

6. The cargo restraint panel of claim 1, wherein the enhanced friction layer covers substantially all of the core front.

7. The cargo restraint panel of claim 1, further comprising:
a second enhanced friction layer, covering at least a portion of the core rear and having a first exposed surface forming at least a portion of an exterior face of a rear of the cargo restraint panel, that comprises one or more of: a natural rubber, a synthetic rubber, a silicone, a low-tack acrylic pressure-sensitive adhesive, or a hook and loop fastener system component material.

8. The cargo restraint panel of claim 1, wherein the enhanced friction layer is wrapped continuously around the core front, core rear, and at least one of the plurality of core sides.

9. The cargo restraint panel of claim 1, further comprising one or more additional enhanced friction layers covering one or more additional portions of the core front and having one or more additional exposed surfaces forming one or more additional portions of the exterior face of the front of the cargo restraint panel.

10. A cargo restraint panel comprising:
a foam core comprising a core front, a core rear, and a plurality of core sides extending between the core front and the core rear;
a first side cap that covers a first core side of the plurality of core sides, a first portion of the core front adjacent to the first core side, and a first portion of the core rear adjacent to the first core side;
a second side cap that covers a second core side of the plurality of core sides, a second portion of the core front adjacent to the second core side, and a second portion of the core rear adjacent to the second core side;
an enhanced friction layer covering a portion of the core front and having a first exposed surface forming a portion of an exterior face of a front of the cargo restraint panel; and
a front barrier covering at least another portion of the core front and having a second exposed surface forming at least another portion of the exterior face of the front of the cargo restraint panel, wherein a static coefficient of friction of the first exposed surface is greater than a static coefficient of friction of the second exposed surface.

11. The cargo restraint panel of claim 10, wherein the first exposed surface comprises surface features that comprise one or more of ridges or protrusions.

12. The cargo restraint panel of claim 10, wherein:
the cargo restraint panel is rectangular in shape;
first and second sides of the cargo restraint panel, respectively corresponding to the first side cap and second side cap, are longer than third and fourth sides of the cargo restraint panel; and
the enhanced friction layer extends along substantially all of the third side and is absent from a portion of the exterior face that is adjacent to, and that extends along substantially all of, the fourth side of the cargo restraint panel.

13. The cargo restraint panel of claim 10, wherein:
the cargo restraint panel is rectangular in shape;
first and second sides of the cargo restraint panel, respectively corresponding to the first side cap and second side cap, are longer than third and fourth sides of the cargo restraint panel; and
the enhanced friction layer extends along substantially all of the second side and is absent from a portion of the exterior face that is adjacent to, and that extends along substantially all of, the first side of the cargo restraint panel.

14. The cargo restraint panel of claim 10, further comprising:
a second enhanced friction layer covering a portion of the core rear and having a third exposed surface forming a portion of an exterior face of a rear of the cargo restraint panel; and
a rear barrier covering at least another portion of the core rear and having a fourth exposed surface forming at least another portion of the exterior face of the rear of the cargo restraint panel, wherein a static coefficient of friction of the third exposed surface is greater than a static coefficient of friction of the fourth exposed surface.

15. The cargo restraint panel of claim 10, further comprising:
a second enhanced friction layer covering a portion of the core front and having a third exposed surface forming another portion of the exterior face of the front of the cargo restraint panel, wherein the static coefficient of friction of the third exposed surface is greater than a static coefficient of friction of the second exposed surface.

16. The cargo restraint panel of claim 10, wherein the enhanced friction layer is wrapped continuously around the core front, core rear, and at least one of the plurality of core sides.

17. A method comprising:
placing a plurality of cargo units in a railcar;
placing a plurality of cargo restraint panels in the railcar; and
placing one or more dunnage air bags in the railcar;
wherein each of at least first and second cargo restraint panels, of the plurality of cargo restraint panels, comprise:
a foam core comprising a core front, a core rear, and a plurality of core sides extending between the core front and the core rear;
a front enhanced friction layer, covering at least a portion of the core front and having a first exposed surface forming at least a portion of an exterior face of a front of the cargo restraint panel, that comprises one or more of: a natural rubber, a synthetic rubber, a silicone, a low-tack acrylic pressure-sensitive adhesive, or a hook and loop fastener system component material; and
a rear enhanced friction layer, covering at least a portion of the core rear and having a second exposed surface forming at least a portion of an exterior face of a rear of the cargo restraint panel, that comprises one or more of: a natural rubber, a synthetic rubber, a silicone, a low-tack acrylic pressure-sensitive adhesive, or a hook and loop fastener system component material; and
wherein, after the placing of the plurality of cargo units in the railcar, the placing of the plurality of cargo restraint panels in the railcar, and the placing one or more dunnage air bags in the railcar:
the plurality of cargo units and the plurality of cargo restraint panels are arranged, in a front to rear direction of the railcar, in alternating groups of one or more cargo units, of the plurality of cargo units, separated by one or more restraint panels, of the one or more restraint panels,
a dunnage air bag, of the one or more dunnage air bags, is located between, and is partially compressed by, the first cargo restraint panel and the second cargo restraint panel, and
the dunnage air bag is contact with the first exposed surface of the first cargo restraint panel and the second exposed surface of the second cargo restraint panel.

18. The method of claim 17, wherein, after the placing or the plurality of cargo units in the railcar, the placing of the plurality of cargo restraint panels in the railcar, and the placing one or more dunnage air bags in the railcar:
a second dunnage air bag, of the one or more dunnage air bags, is located between, and is partially compressed by, the first cargo restraint panel and the second cargo restraint panel, and
the second dunnage air bag is in contact with the first exposed surface of the first cargo restraint panel and the second exposed surface of the second cargo restraint panel.

19. The method of claim 17, wherein each of the first and second cargo restraint panels is rectangular in shape, and wherein for each of the first and second cargo restraint panels:
first and second sides, of the plurality of core sides, respectively located on opposites sides of the foam core, are longer than a third and fourth sides of the plurality of sides;
a barrier covers at least a portion of the core front and has a third exposed surface forming a portion of the exterior face of the front of the cargo restraint panel, wherein a static coefficient of friction of the first exposed surface is greater than a static coefficient of friction of the third exposed surface; and
the front enhanced friction layer extends along substantially all of the third side and is absent from a portion of the exterior face that is adjacent to, and that extends along substantially all of, the fourth side of the cargo restraint panel.

20. The method of claim 17, at least the front enhanced friction layer of the first cargo restraint panel comprises surface features that comprise one or more of ridges or protrusions.
